(19) United States
(12) Patent Application Publication
(10) Pub. No.: US 2008/0125499 A1
(43) Pub. Date: May 29, 2008

(54) Aqueous Dispersions of a Mixture of Only Slightly Water Soluble or Water Insoluble Active Substances and a Single-Celled Protein Material

(75) Inventors: Jesper Feldthusen Jensen, Mainz (DE); Lutz End, Weinheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/791,697

(22) PCT Filed: Nov. 26, 2005
(86) PCT No.: PCT/EP05/12652

§ 371 Date: May 25, 2007

(30) Foreign Application Priority Data
Nov. 29, 2004 (DE) 10 2004 057 587.8

(51) Int. Cl. B01F 17/30

(52) U.S. Cl. 516/69

(57) ABSTRACT

The present invention relates to aqueous dispersions comprising at least one slightly water-soluble or water-insoluble active compound and at least one protein as protective colloid, wherein the protein is a single cell protein material produced by fermentation.

The present invention relates to aqueous dispersions comprising at least one slightly water-soluble or water-insoluble active compound and at least one protein as protective colloid, wherein the protein is a single cell protein material produced by fermentation.

Numerous active compounds suitable for the animal feedstuff and foodstuff sector or for pharmaceutical and cosmetic applications, for example fat-soluble vitamins, carotenoids, but also the natural colorants curcumin or carmine and also numerous UV filters, owing to their water insolublility and/or their sensitivity to oxidation, can only be used in the form of specially stabilized preparations. Direct use of the crystalline materials, inter alia, for coloring aqueous foodstuffs, as feed additives, or as active compounds and effect compounds in cosmetic preparations is generally impossible. The high requirements with respect to bioavailability, coloring properties and dispersibility, in particular in aqueous media, but also in lipophilic media, can only be met by means of special formulations.

Only by means of preparations in which the active compounds, for example carotenoids, are present in finely divided form and protected against oxidation by protective colloids, may satisfactory color yields be achieved in the direct coloration of foods. These formulations used in animal feedstuff lead to a higher bioavailability of the active compounds and thus indirectly to improved coloring effects, for example in the pigmenting of egg yolks or fish.

From the literature, a number of the most varied formulation methods are already known, all of which methods have the purpose of reducing the crystallite size of the active compounds and bringing it to a particle size range of less than 10 μm.

Numerous methods, described, inter alia in Chimia 21, 329 (1967), WO 91/06292 and also in WO 94/19411, make use of the grinding of carotenoids by means of a colloid mill and achieve particle sizes of from 2 to 10 μm by this means.

In addition, combined emulsification/spray-drying methods exist, as are described, for example, in DE-A-12 11 911 or in EP-A-0 410 236.

According to European patent EP-B-0 065 193, finely divided pulverulent carotenoid preparations are produced by dissolving β-carotene, for example, in a volatile water-miscible organic solvent at temperatures between 50° C. and 200° C., if appropriate under elevated pressure within a time of less than 10 seconds. The β-carotene is precipitated from the resultant molecular dispersion by immediate rapid mixing with an aqueous solution of a protective colloid at temperatures between 0° C. and 50° C. This produces in this way a colloidally disperse β-carotene hydrosol having orange-yellowish color tone. Subsequent spray drying of the dispersion gives a free-flowing dry powder which dissolves in water forming a clear yellow-orange dispersion.

A similar method for producing finely divided pulverulent carotenoid preparations is described in EP-A-0 937 412 using water-immiscible solvents.

WO 98/26008 relates to the use of a mixture of low-molecular-weight and high-molecular-weight protective colloids for producing redispersible xanthophyll-containing dry powders.

The purpose of the present invention is to convert, from here, hydrophobic slightly water-soluble or water-insoluble active compounds and effect compounds into stable aqueous dispersions or into stable and readily redispersible dry powders.

Stable, within the meaning of the invention, means that the formulations are, inter alia, oxidation-stable and photostable, and also stable to sedimentation and creaming, over a period and temperature range sufficient for the respective application.

It is an object of the present invention, therefore, to provide natural polymers which can be used as protective colloids, in particular in feedstuffs, drugs, foods, food supplements and cosmetics.

The inventive object has been achieved by aqueous dispersions comprising at least one slightly water-soluble or water-insoluble active compound and at least one protein as protective colloid, wherein the protein is a single cell protein material produced by fermentation.

The term single cell protein material comprises, in the context of the present invention, in general those proteins which may be produced by biosynthetic methods, for example by fermentation of single celled microorganisms. Preferred single cell microorganisms which may be mentioned here are algae, fungi, yeasts and bacteria. Particular preference is given to all yeast and bacteria, very particular preference to bacteria, which are authorized for the foodstuff and animal feedstuff sectors.

As suitable bacteria, use may be made of, for example, chemoorganotrophic bacteria, in particular not only methanotrophic, but also heterotrophic bacteria, or mixtures thereof. More detailed explanations on the various types of bacteria may be found, inter alia, in EP 1 265 982 B1. The bacterial strains disclosed there may be mentioned as preferred microorganisms for producing the single cell protein material.

The single cell protein material produced by the microbiological methods can be used in purified form, or as a mixture together with the biomass produced in the fermentation, as protective colloid for the inventive aqueous dispersions. In this case it is advantageous if the biomass is free from cell wall material.

In a preferred embodiment, the single cell protein material is used in a mixture with a homogenized biomass which is freed from cell wall material as protective colloid for the inventive aqueous dispersions. It is advantageous here to use this homogenized mixture as spray-dried granules.

Details on homogenizing the biomass may likewise be found in EP 1 265 982 B1.

The inventively used single cell protein material, in the form of a homogenized bio-mass, in addition comprises from 50 to 90% by weight, preferably from 60 to 80% by weight, of protein.

The term aqueous dispersions, in the context of the present invention, is taken to mean, according to the physical state of matter of the slightly water-soluble or water-insoluble active compounds, not only aqueous suspensions, but also emulsions. Preferably, aqueous suspensions may be mentioned in which the dispersed phase comprises at least one slightly water-soluble or water-insoluble active compound as nanoparticulate particles. Furthermore, principal roles in the invention are also played by the dry powder or emulsions, preferably double emulsions, in particular o/w/o emulsions produced from the above aqueous dispersions.

Slightly water-soluble organic compounds, in this context, are taken to mean those compounds, the water solubility of which is <5% by weight, preferably <1% by weight, particularly preferably <0.1% by weight, very particularly preferably <0.01% by weight.

As active compounds which are suitable in the context of the present invention for the foodstuff and animal nutrition sector, and also for pharmaceutical and cosmetic applications, the following compounds may be mentioned by way of example:

Fat-soluble vitamins, for example the K vitamins, vitamin A and derivatives such as vitamin A acetate, vitamin A propionate or vitamin A palmitate, vitamin D₂ and vitamin D₃, and also vitamin E and derivatives. Vitamin E in this context is natural or synthetic α-, β-, γ- or δ-tocopherol, preferably natural or synthetic α-tocopherol, and also tocotrienol. Vitamin E derivatives are, for example, tocopheryl C₁-C₂₀-carboxylic esters, such as tocopheryl acetate or tocopheryl palmitate.

Polyunsaturated fatty acids, for example linoleic acid, linolenic acid, arachidonic acid, eicosapentaenoic acid, docosahexaenoic acid.

Food colorants such as curcumin, carmine or chlorophyll.

Carotenoids, not only carotenes but also xanthophylls, for example β-carotene, lycopene, lutein, astaxanthin, zeaxanthin, capsanthin, capsorubin, cryptoxanthin, citranaxanthin, canthaxanthin, bixin, β-apo-4-carotenal, β-apo-8-carotenal and β-apo-8-carotenoic acid ethyl ester.

Phytosterols, coenzyme Q10.

Water-insoluble or slightly water-soluble organic UV filter substances, for example compounds from the group of the triazines, anilides, benzophenones, triazoles, cinnamides and also the sulfonated benzimidazoles.

Preferred active compounds are carotenoids, in particular β-carotene, lycopene, lutein, astaxanthin and canthaxanthin, and also vitamin A and vitamin E and, from the series of UV filter substances, the triazine class, in particular Uvinul T150.

A particularly preferred embodiment of the inventive aqueous dispersions is that in this case they are aqueous suspensions which comprise at least one slightly water-soluble or water-insoluble active compound selected from the group of the carotenoids, consisting of β-carotene, lycopene, lutein, astaxanthin and canthaxanthin, as nanoparticulate particles.

The mean particle size of the nanoparticulate particles in the aqueous dispersion is, depending on the type of formulation method, in the range from 0.01 to 100 μm, preferably in the range from 0.01 to 10 μm, particularly preferably in the range from 0.01 to 2 μm, very particularly preferably in the range from 0.02 to 1 μm.

The amounts of the various components of the inventive dispersions, in particular suspensions, are, according to the invention, chosen in such a manner that the preparations from 0.1 to 90% by weight, preferably from 2 to 40% by weight, particularly preferably from 3 to 30% by weight, very particularly preferably from 5 to 25% by weight, of at least one slightly water-soluble or water-insoluble active compound, from 0.1 to 99.9% by weight, preferably from 5 to 70% by weight, particularly preferably from 10 to 60% by weight, of a single cell protein produced by fermentation. The percentages by weight are based in each case on the dry mass of the formulation.

In addition the preparations can further comprise low-molecular-weight stabilizers such as antioxidants and/or preservatives for protecting the active compounds. Suitable antioxidants or preservatives are, for example, α-tocopherol, ascorbic acid, tertiary-butyl hydroxytoluene, tertiary-butyl hydroxyanisole, lecithin, ethoxyquin, methylparaben, propylparaben, sorbic acid or sodium benzoate. The antioxidants or preservatives can in amounts of from 0.01 to 50% by weight, preferably from 0.1 to 30% by weight, particularly preferably from 0.5 to 20% by weight, very particularly preferably from 1 to 10% by weight, based on the dry mass of the formulation.

In addition, the dispersions can further comprise plasticizers to increase the mechanical stability of a dry powder, if appropriate produced therefrom. Suitable plasticizers are, for example, sugars and sugar alcohols, such as sucrose, maltose, glucose, lactose, trehalose, invert sugar, sorbitol, mannitol, xylitol, glucose syrup, maltodextrin or glycerol. Preferably, as plasticizer, use is made of sucrose or lactose. The plasticizers can be present in amounts of from 0.1 to 70% by weight, preferably from 10 to 60% by weight, particularly preferably from 20 to 50% by weight, based on the dry mass of the formulation.

Furthermore, the dispersions can comprise low-molecular-weight surface-active compounds (emulsifiers) at a concentration of from 0.01 to 70% by weight, preferably from 0.1 to 50% by weight, particularly preferably from 0.5 to 20% by weight, based on the dry mass of the formulation. Compounds which are suitable as such are, especially, amphiphilic compounds or mixtures of such compounds. In principle, all surfactants having an HLB value of from 5 to 20 come into consideration. As corresponding surface-active substances, the following, for example, come into consideration: esters of long-chain fatty acids with ascorbic acid, mono- and diglycerides of fatty acids and their oxyethylation products, esters of mono fatty acid glycerides with acetic acid, citric acid, lactic acid or diacetyltartaric acid, polyglycerol esters of fatty acids, for example the monostearate of triglycerol, sorbitan fatty acid esters, propylene glycol fatty acid esters and lecithin. Preferably, ascorbyl palmitate is used.

For the production of carotenoid-comprising emulsions, it can also be advantageous to use in addition a physiologically approved oil, for example sesame oil, corn germ oil, cottonseed oil, soybean oil or peanut oil, and also cosmetic oils, for example paraffin oil, glyceryl stearate, isopropyl myristate, diisopropyl adipate, cetyl-stearyl 2-ethylhexanoate, hydrogenated polyisobutene, Vaseline, caprylic acid/capric acid triglycerides, microcrystalline wax, lanolin and stearic acid in a concentration of from 0.1 to 500% by weight, preferably from 10 to 300% by weight, particularly preferably from 20 to 100% by weight, based on the slightly water-soluble or water-insoluble active compound or active compounds used.

As a further preferred embodiment, the inventive aqueous dispersions are characterized in that they are o/w emulsions of vitamin A and/or vitamin E or derivatives thereof mentioned at the outset in an aqueous molecular dispersion or colloidal dispersion of a single cell protein material produced by fermentation.

The invention also relates to a method for producing an aqueous dispersion of at least one slightly water-soluble or water-insoluble active compound by dispersing one or more slightly water-soluble or water-insoluble active compounds in an aqueous molecular dispersion or colloidal dispersion of a proteinaceous protective colloid, characterized in that the protein is a single cell protein material produced by fermentation.

A preferred embodiment of the inventive method is that the dispersion step is the production of a suspension or emulsion of at least one slightly water-soluble or water-insoluble active compound in an aqueous molecular dispersion or colloidal dispersion of a proteinaceous protective colloid, wherein the protein is a single-cell protein material produced by fermentation.

A particularly preferred embodiment of the method is characterized in that the dispersion, in particular suspension, comprises the following steps:
a₁) dissolving at least one slightly water-soluble or water-insoluble active compound in one or more water-miscible organic solvents, or in a mixture of water and one or more water-miscible organic solvents, or
a₂) dissolving at least one slightly water-soluble or water-insoluble active compound in one or more water-immiscible organic solvents,
b) mixing the solution obtained after a₁) or a₂) with an aqueous molecular dispersion or colloidal dispersion of a single cell protein material produced by fermentation, the hydrophobic phase of the slightly water-soluble or water-insoluble active compound being produced as nanodisperse phase and
c) separating off the organic solvent.

The water-miscible solvents used in stage a₁) to be mentioned are primarily water-miscible thermally stable volatile solvents which contain only carbon, hydrogen and oxygen, such as alcohols, ethers, esters, ketones and acetals. Expediently, use is made of those solvents which are at least 10% water-miscible, have a boiling point below 200° C. and/or have less than 10 carbons. Particular preference is given to methanol, ethanol, n-propanol, isopropanol, 1,2-butanediol 1-methyl ether, 1,2-propanediol 1-n-propyl ether, tetrahydrofuran or acetone.

The term “a water-immiscible organic solvent” in the meaning of the present invention is an organic solvent having a water solubility at atmospheric pressure of less than 10%. Possible solvents which come into consideration here are, inter alia, halogenated aliphatic hydrocarbons, for example methylene chloride, chloroform and carbon tetra-chloride, carboxylic esters such as dimethyl carbonate, diethyl carbonate, propylene carbonate, ethyl formate, methyl, ethyl or isopropyl acetate and also ethers such as methyl tert-butyl ether.

As a water-immiscible organic solvent, according to the invention the oils mentioned at the outset must also be mentioned.

Preferred water-immiscible organic solvents are the following compounds from the group consisting of dimethyl carbonate, propylene carbonate, ethyl formate, ethyl acetate, isopropyl acetate and methyl tert-butyl ether.

As particularly preferred solvent for the dispersion/suspension step, use is made of at least one water-miscible organic solvent or a mixture of water and at least one water-miscible organic solvent, very particularly preferably isopropanol or acetone.

An advantageous embodiment of the abovementioned inventive method is characterized in that, in step a), the molecular dispersion of at least one slightly water-soluble or water-insoluble active compound is produced at temperatures above 30° C., preferably between 50° C. and 240° C., in particular from 100° C. to 200° C., particularly preferably from 140° C. to 180° C., if appropriate under pressure, and immediately subsequently, in step b), admixed with the aqueous solution of the protective colloid, a mixture temperature of from 35° C. to 120° C. being set.

The solvent component is converted into the aqueous phase and the hydrophobic phase of the active compound or of the active compounds is produced as nanodisperse phase.

With regard to a more detailed method and apparatus description for the abovementioned dispersion, reference is made at this point to EP-B-0 065 193.

The invention further relates to a method for producing a dry powder comprising at least one slightly water-soluble or water-insoluble active compound as nanoparticulate particles, characterized in that the above-described aqueous emulsions, for example aqueous vitamin A- and/or vitamin E-comprising emulsions or, in the case of carotenoid-comprising formulations, in particular suspensions, are freed from water and dried.

The conversion into a dry powder can take place, inter alia, by spray drying, spray cooling, freeze drying or drying in the fluidized bed, if appropriate also in the presence of a coating material. Suitable coating materials are, inter alia, corn starch or silica.

A preferred embodiment of the abovementioned method is characterized in that the suspension produced of at least one slightly water-soluble or water-insoluble active compound is ground before the conversion to a dry powder.

The grinding can be performed in this case in a manner known per se, for example using a ball mill. Depending on the mill type used in this case grinding is continued until the particles have a mean particle size determined via Fraunhofer diffraction D[4,3] of from 0.1 to 100 μm, preferably from 0.2 to 50 μm, particularly preferably from 0.2 to 20 μm, very particularly preferably from 0.2 to 5 μm, in particular 0.2 to 0.8 μm. The term D[4,3] designates the volume-weighted mean diameter (see Handbook for the Malvern Mastersizer S, Malvern Instruments Ltd., UK).

Further details on the grinding and the equipment set-ups used therefor may be found, inter alia, in Ullmann's Encyclopedia of Industrial Chemistry, Sixth Edition, 2000, Electronic Release, Size Reduction, chapter 3.6.: Wet Grinding, and also in EP-A-0 498 824.

A particularly preferred embodiment of the inventive method for producing one of the abovementioned dry powders is characterized in that
a) at least one slightly water-soluble or water-insoluble active compound is dissolved in a water-miscible organic solvent, or a mixture of water and a water-miscible organic solvent, at temperatures above 30° C.,
b) the resultant solution is mixed with an aqueous molecular dispersion or colloidal dispersion of a single cell protein material produced by fermentation and
c) the dispersion formed is converted into a dry powder.

The invention also relates to pulverulent preparations of at least one slightly water-soluble or water-insoluble active compound, obtainable by one of the above-mentioned methods.

The invention likewise relates to a method for producing an oil-miscible preparation in the form of a double dispersion, comprising at least one slightly water-soluble or water-insoluble active compound, characterized in that the aqueous dispersions described at the outset are emulsified in oil.

In this case, using an emulsifier, a water-in-oil emulsion is formed in which the water phase comprises protective colloid-stabilized nanoparticles of at least one slightly water-soluble or water-insoluble organic UV filter substance. Emulsifiers which come into consideration are W/O emulsifiers which are known per se and have an HLB value less than 10, in particular from 2 to 6 (see H. P. Fiedler, Lexikon der Hilfsstoffe für Pharmazie, Kosmetik und angrenzende Gebiete [Lexikon of aids for pharmacy, cosmetics and related sectors], 1996, pages 753 ff). Typical representatives of this class of emulsifiers are partial fatty acid esters of polyhydric alcohols, for example glycerol monostearate, or mixtures of mono-, di- and triglycerides, partial fatty acid esters of sorbitan, and/or preferably fatty acid esters of polyglycerol, for example polyglycerol polyricinoleate which are used in a concentration of from 10 to 1000% by weight, preferably from 100 to 900% by weight, particularly preferably from 400 to 800% by weight, based on the active compound or active compounds.

The dispersion medium can be not only of synthetic origin, mineral origin, plant origin, but also of animal origin. Typical representatives are, inter alia, sesame oil, corn germ oil, cottonseed oil, soybean oil or peanut oil, esters of medium-chain plant fatty acids and also paraffin oil, glyceryl stearate, isopropyl myristate, diisopropyl adipate, cetyl-stearyl 2-ethylhexanoate, hydrogenated polyisobutane, Vaseline, caprylic acid/capric acid triglycerides, microcrystalline wax, lanolin and stearic acid. The amount of the dispersion medium is generally from 30 to 95% by weight, preferably from 50 to 80% by weight, based on the total mass of the finished emulsion.

The emulsification can be carried out continuously or batchwise.

The physical stability of the double dispersion system, for example the sedimentation stability, is achieved by a very good fine distribution of the water phase in the oil phase for example by intensive treatment using a rotor/stator disperser at temperatures of from 20 to 80° C., preferably from 40 to 70° C., or using a high-pressure homogenizer such as APV Gaulin, or using a very high pressure homogenizer such as the Microfluidizer in the pressure range from 700 to 1000 bar. The mean diameters achievable thereby of the aqueous-disperse phase are less than 500 μm, preferably less than 100 μm, particularly preferably less than 10 μm, in particular less than 1 μm.

The invention also relates to liquid oil-miscible preparations of at least one slightly water-soluble or water-insoluble active compound obtainable by abovementioned methods, characterized in that they comprise, as double dispersion systems, an aqueous-disperse phase having a particle diameter less than 500 μm in which protective-colloid-stabilized particles of one or more slightly water-soluble or water-insoluble active compounds are present in dispersed form in an oil as dispersion medium.

The invention also relates to the use of the abovementioned aqueous dispersion as additive to foodstuffs, food supplements, animal feedstuffs, pharmaceutical and cosmetic preparations.

The invention also relates to the use of the abovementioned pulverulent preparations as additive to foodstuffs, food supplements, animal feedstuffs, pharmaceutical and cosmetic preparations.

The invention also relates to the use of the abovementioned liquid oil-miscible preparations as additive to foodstuffs, food supplements, animal feedstuffs, pharmaceutical and cosmetic preparations.

The invention will be described in more detail below with reference to the example.

### EXAMPLE 1

### Production of an Aqueous Astaxanthin Suspension and Subsequent Conversion into a Dry Powder

In a heatable receiver, at a temperature of 30° C., 20 g of astaxanthin, 10 g of ethoxyquin (EQ) and 2 g of ascorbyl palmitate are suspended in 294 g of isopropanol/water (88/12, w/w). This suspension is mixed in a mixing chamber at a mixture temperature of 170° C. with 536 g of isopropanol/water (88/12, w/w) at a residence time of 0.2 seconds. After said residence time, the resultant astaxanthin molecular dispersion then passes directly into a further mixing chamber in which are added, at a mixing angle of 90°, via a high-pressure pump, 6.5 kg of an aqueous solution set to pH 8 comprising 60 g of a single cell protein material produced by fermentation and in addition 110 g of sucrose, the astaxanthin in colloidally disperse form having a mean particle size of from 100 to 300 nm being precipitated out at a temperature of 45° C.

The dispersion is then concentrated and converted in a manner known per se into a free-flowing 10% strength astaxanthin dry powder having a mean particle size of from 50 to 200 μm.

### EXAMPLE 2

### Production of an Aqueous Vitamin A Acetate Emulsion and Subsequent Conversion into a Dry Powder

80 g of lactose in 500 g of water are charged in a stirred flask and admixed with 100 g of a single cell protein material produced by fermentation. The mixture is agitated briefly for approximately 1 min, allowed to swell for 20 min at 60° C., and subsequently stirred for 5 min at 400 rpm. The water phase is transferred to a glass beaker. The vitamin A acetate (50 g) and ethoxyquin (EQ, 10 g) mixture is added to the water phase and emulsified into the water phase for 1 min at 5000 rpm. The emulsion is then transferred to an autoclave and spray-formulated using a powdering aid.

1. An aqueous dispersion comprising at least one slightly water-soluble or water-insoluble active compound and at least one protein as protective colloid, wherein the protein is a single-cell protein material produced by fermentation.

2. The aqueous dispersion according to claim 1, wherein the single-cell protein material is a protein material produced by fermentation by at least one microorganism selected from the group consisting of fungi, yeasts and bacteria.

3. The aqueous dispersion according to claim 1, wherein the aqueous dispersion comprises the single cell protein material in purified form or as a mixture with the biomass produced in the fermentation.

4. The aqueous dispersion according to claim 3, wherein the aqueous dispersion comprises the single cell protein material in the form of a homogenized biomass.

5. The aqueous dispersion according to claim 1, wherein the single cell protein material comprises from 50 to 90% by weight of protein.

6. The aqueous dispersion according to claim 1, wherein the aqueous dispersion is an emulsion or suspension.

7. The aqueous dispersion according to claim 6, wherein the suspension comprises at least one slightly water-soluble or water-insoluble active compound as nanoparticulate particles.

8. The aqueous dispersion according to claim 1 comprising from 0.1 to 90% by weight of at least one slightly water-soluble or water-insoluble active compound and from 0.1 to 99.9% by weight of single cell protein material produced by fermentation, all percentages being based on the dry mass of the aqueous dispersion.

9. The aqueous dispersion according to claim 8 additionally comprising from 0.1 to 70% by weight of at least one plasticizer, from 0.01 to 70% by weight of at least one emulsifier, and/or from 0.01 to 50% by weight of at least one antioxidant and/or preservative.

10. A method for producing an aqueous dispersion of at least one slightly water-soluble or water-insoluble active compound comprising dispersing one or more slightly water-soluble or water-insoluble active compounds in an aqueous molecular dispersion or colloidal dispersion of a proteinaceous protective colloid, wherein the proteinaceous protective colloid comprises a single-cell protein material produced by fermentation.

11. The method according to claim 10, wherein the dispersion step is the production of a suspension or emulsion of at least one slightly water-soluble or water-insoluble active compound in an aqueous molecular dispersion or colloidal dispersion of a single-cell protein material produced by fermentation.

12. The method of claim 11 wherein the production of a suspension comprises the following steps:
a₁) dissolving at least one slightly water-soluble or water-insoluble active compound in one or more water-miscible organic solvents, or in a mixture of water and one or more water-miscible organic solvents, or
a₂) dissolving at least one slightly water-soluble or water-insoluble active compound in one or more water-immiscible organic solvents,
b) mixing the solution obtained after a₁) or a₂) with an aqueous molecular dispersion or colloidal dispersion of a single cell protein material produced by fermentation, the hydrophobic phase of the slightly water-soluble or water-insoluble active compound being produced as a nanodisperse phase and
c) separating off the organic solvent.

13. The method according to claim 12, wherein the organic solvent for the dispersion step is at least one water-miscible organic solvent, or a mixture of water and at least one water-miscible organic solvent.

14. The method according to claim 12, wherein, in step a), the molecular dispersion is produced from at least one slightly water-soluble or water-insoluble active compound at temperatures above 30° C. and immediately afterward is admixed in step b) with the aqueous solution of the protective colloid at a mixture temperature of from 35° C. to 120° C.

15. A method for producing a dry powder having at least one slightly water-soluble or water-insoluble active compound as nanoparticulate particles, comprising the steps of
a) freeing from water an aqueous dispersion comprising at least one slightly water-soluble or water-insoluble active compound and at least one protein as protective colloid, wherein the protein is a single-cell protein material produced by fermentation; and
b) drying, optionally in the presence of a coating material.

16. The method according to claim 15, wherein the aqueous dispersion is an aqueous suspension or emulsion of at least one slightly water-soluble or slightly water-insoluble active compound.

17. The method according to claim 16, wherein, in the case of a suspension, the suspended particles are ground before the conversion into a dry powder.

18. The method according to claim 15, wherein
a) at least one slightly water-soluble or water-insoluble active compound is dissolved in a water-miscible organic solvent, or a mixture of water and a water-miscible organic solvent, at temperatures above 30° C.,
b) the resultant solution is mixed with an aqueous molecular dispersion or colloidal dispersion of a single cell protein material produced by fermentation and
c) the dispersion formed is converted into a dry powder.

19. A pulverulent preparation of at least one slightly water-soluble or water-insoluble active compound produced by the method of claim 15.

20. A method for producing an oil-miscible preparation of at least one slightly water-soluble or water-insoluble active compound, comprising emulsifying in oil in the presence of an emulsifier the aqueous dispersion of claim 1.

21. A liquid oil-miscible preparation of at least one slightly water-soluble or water-insoluble active compound produced by the method of claim 20, wherein the preparation comprises as double dispersion systems an aqueous-disperse phase having a particle diameter less than 500 μm in which protective-colloid-stabilized particles of one or more slightly water-soluble or water-insoluble active compounds are present in dispersed form, in an oil as dispersion medium.

22. An additive which comprises the aqueous dispersion claim 1, wherein the additive is a foodstuff, food supplement, animal feedstuff, pharmaceutical or cosmetic preparation additive.

23. An additive which comprises the pulverulent preparation of claim 19, wherein the additive is a foodstuff, food supplement, animal feedstuff, pharmaceutical cosmetic preparation additive.

24. An additive which comprises the liquid oil-miscible preparation of claim 21, wherein the additive is a foodstuff, food supplement, animal feedstuff, pharmaceutical or cosmetic preparation additive.
